(19) United States
(12) Patent Application Publication
(10) Pub. No.: US 2010/0163317 A1
(43) Pub. Date: Jul. 1, 2010

(54) ELECTRONIC DEVICE AND LIGHT EMITTING TOUCHPAD THEREOF

(75) Inventor: Tzu-Wei Tai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/647,544

(22) Filed: Dec. 28, 2009

(30) Foreign Application Priority Data
Dec. 31, 2008 (TW) 97151883

(51) Int. Cl. G06F 3/042

(52) U.S. Cl. 178/18.09

(57) ABSTRACT

A light emitting touchpad and an electronic device are provided. The light emitting touchpad disposed at a main body of the electronic device includes a light emitting module, a touch control module and a controller. The light emitting module includes a light guiding plate and multiple light emitting elements. The light guiding plate includes multiple blocking walls and multiple light guiding portions. The blocking walls and the light guiding portions are interlacing with each other. Each of the light guiding portions has an incident side. The light emitting elements are disposed beside the incident sides of the light guiding portions. The touch control module is coinciding with the light guiding plate. The controller electrically connected with the light emitting elements and the touch control module controls at least part of the light emitting element to emit light according to an instruction detected by the touch control module.

### CROSS-REFERENCE TO RELATED APPLICATION

This application claims the priority benefit of Taiwan application serial no. 97151883, filed on Dec. 31, 2008. The entirety of the above-mentioned patent application is hereby incorporated by reference herein and made a part of specification.

### BACKGROUND OF THE INVENTION

1. Field of the Invention

The invention relates to an electronic device and a touchpad thereof and, more particularly, to an electronic device and a light emitting touchpad thereof.

2. Description of the Related Art

As the electronic technology is developed and used more and more widely, life rely on the electronic product is also increasing day by day, and various input devices (such as a keyboard, a mouse, a touch device and trackball) are used to input data or operate the electronic product. The touch device has a small dimension and may be operated easily in small space, and therefore, it is widely integrated in electronic products such as a notebook, a personal digital assistant (PDA) and a mobile phone.

However, the touchpad provides no substantial feedback while using which is different from the conventional tangible keyboard. That is, when a user operates the touchpad, he or she does not get any elastic tactility or the acoustical feedback which may be obtained from the tangible keyboard. Thus, it is difficult for the user to confirm whether the data is successfully inputted.

### BRIEF SUMMARY OF THE INVENTION

The invention provides a light emitting touchpad which generates light when touching to provide a visual feedback.

The invention provides an electronic device having a light emitting touchpad providing a preferred operational feeling for the user.

The invention provides a light emitting touchpad including a light emitting module, a touch control module and a controller. The light emitting module includes a first light guiding plate and a plurality of light emitting element, and the first light guiding plate includes a plurality of first blocking walls and a plurality of first light guiding portions. The first blocking walls and the first light guiding portions are interlacing with each other, and each of the first light guiding portions has an incident side. The light emitting elements are disposed beside the incident sides. The touch control module is implemented to detect an instruction inputted by the user, and may be coincide with the first light guiding plate. The controller is electrically connected to the light emitting element and the touch control module, and it controls at least part of the light emitting elements to emit light according to the instruction detected by the touch control module.

The invention provides an electronic device including a main body and a light emitting touchpad. The light emitting touchpad includes a light emitting module, a touch control module and a controller. The light emitting module includes a first light guiding plate and a plurality of light emitting element, and the first light guiding plate includes a plurality of first blocking walls and a plurality of first light guiding portions. The first blocking walls and the first light guiding portions are interlacing with each other, and each of the first light guiding portions has an incident side. The light emitting elements are disposed beside the incident sides. The touch control module is implemented to detect an instruction inputted by the user, and may be coincide with the first light guiding plate. The controller is electrically connected to the light emitting element and the touch control module, and it controls at least part of the light emitting elements to emit light according to the instruction detected by the touch control module.

In an embodiment of the invention, the light emitting elements comprise a plurality of light emitting diodes.

In an embodiment of the invention, the light emitting module further includes a second light guiding plate that coincides with the first light guiding plate. The second light guiding plate includes a plurality of second blocking walls and a plurality of second light guiding portions. The second blocking walls and the second light guiding portions are interlacing with each other, and the second blocking walls and the second light guiding portions are in a perpendicular orientation relative to the first blocking walls and the first light guiding portions.

In an embodiment of the invention, the second blocking walls and the second light guiding portion are integrally formed.

In an embodiment of the invention, the first light guiding plate further includes a first reflecting layer disposed at a bottom surface of the first light guiding plate.

In an embodiment of the invention, the light emitting module further includes a pattern plate that coincides with the first light guiding plate. The pattern plate has patterns formed thereon, for example, a plurality of dot-shaped penetrating portion directly facing the first light guiding portions.

In one embodiment of the invention, the pattern plate further has a second reflecting layer disposed at a surface of the pattern plate where the pattern plate mount with the first light guiding plate.

In one embodiment of the invention, the first blocking walls and the first light guiding portions are integrally formed.

In one embodiment of the invention, the first light guiding portions has a plurality of printed dots.

In one embodiment of the invention, the distributing density of the printed dots in the area adjacent to the incident sides is less than the distributing density of the printed dots in the area far away from the incident sides.

As stated above when the user operates the light emitting touchpad, the light emitting touchpad may light to provide an aesthetic light flashing effect, which provides real-time interactive operational feeling.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an electronic device according to an embodiment of the invention;

FIG. 2 is an exploded diagram showing the light emitting touchpad of the electronic device in FIG. 1;

FIG. 3 is an exploded diagram showing the first light guiding plate of the light emitting module in FIG. 2;

FIG. 4 is a sectional diagram showing the first light guiding plate in FIG. 2 taken along the S plane;

FIG. 5 is a sectional diagram showing the first light guiding plate of the light emitting module according to another embodiment of the invention;

FIG. 6A is a schematic diagram showing the electronic device according to another embodiment of the invention;

FIG. 6B is an exploded diagram showing the light emitting touchpad of the electronic device in FIG. 6A;

FIG. 7A is a partial schematic diagram showing the first light guiding plate and the light emitting elements in the light emitting module according to another embodiment of the invention;

FIG. 7B is a partial sectional diagram showing the first light guiding plate in FIG. 7A;

FIG. 8 is a schematic diagram showing the electronic device according to another embodiment of the invention;

FIG. 9 is an exploded diagram showing the light emitting touchpad of the electronic device in FIG. 8; and

FIG. 10 is a sectional diagram showing the pattern plate in FIG. 9.

### DETAILED DESCRIPTION OF THE EMBODIMENTS

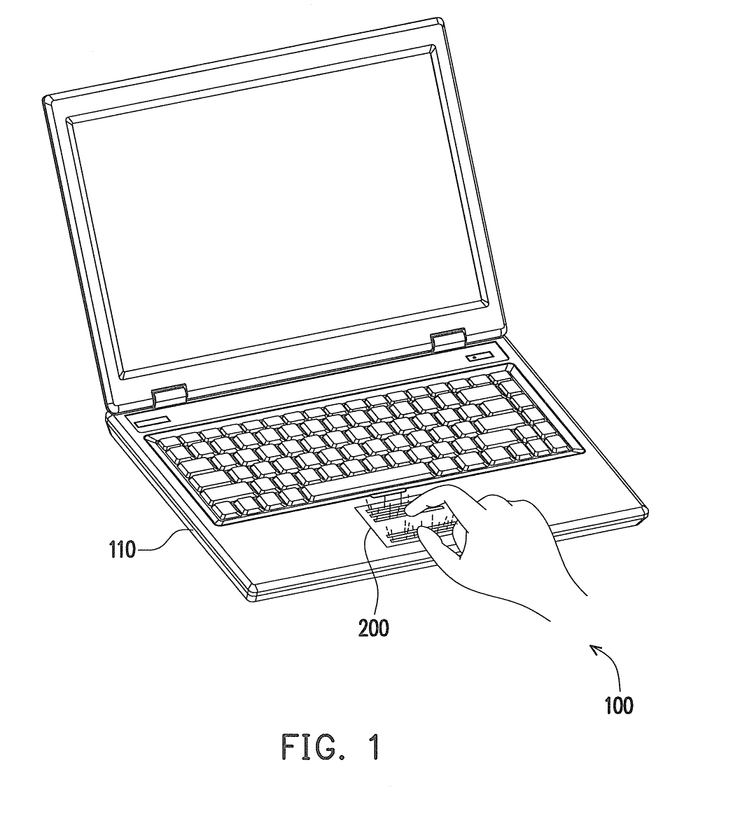

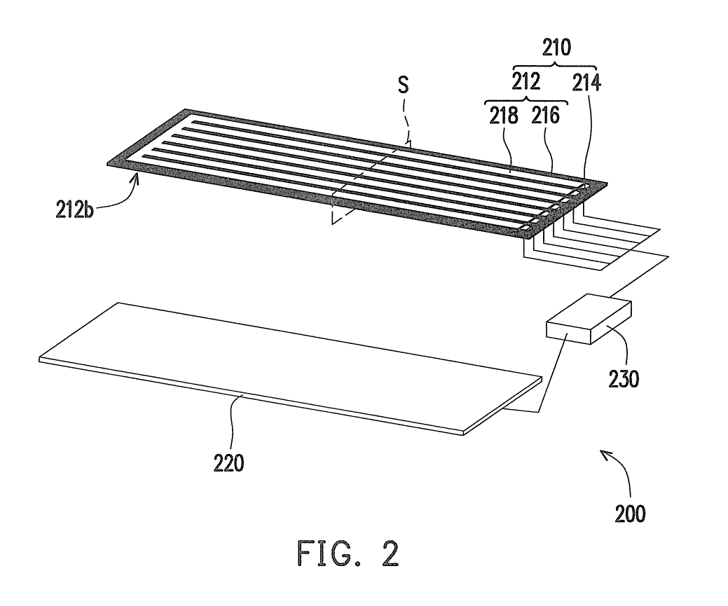

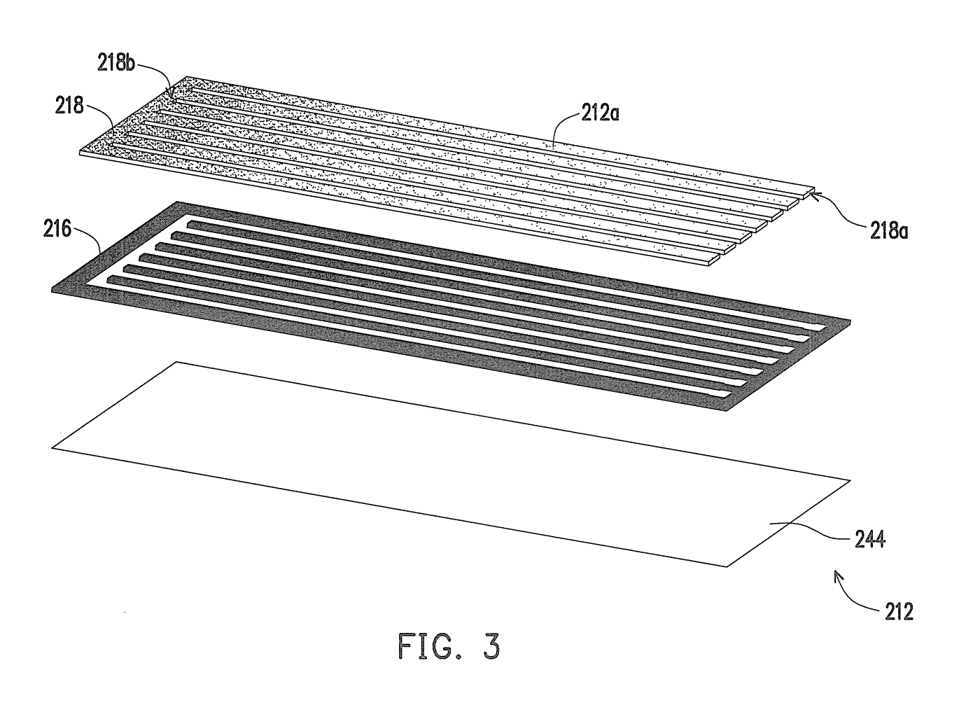

FIG. 1 is a schematic diagram showing an electronic device according to an embodiment of the invention. FIG. 2 is an exploded diagram showing the light emitting touchpad of the electronic device in FIG. 1. As shown in FIG. 1 and FIG. 2, the electronic device 100 includes a main body 110 and a light emitting touchpad 200 disposed on the main body 110. In the embodiment, the light emitting touchpad 200 includes a light emitting module 210, a touch control module 220 and a controller 230. The light emitting module 210 includes a first light guiding plate 212 and a plurality of light emitting elements 214 such as light emitting diodes. The first light guiding plate 212 includes a plurality of first blocking walls 216 and a plurality of first light guiding portions 218, and the first blocking walls 216 and the first light guiding portions 218 are interlacing with each other. FIG. 3 is an exploded diagram showing the first light guiding plate of the light emitting module in FIG. 2. As shown in FIG. 2 and FIG. 3, each first light guiding portion 218 and first blocking wall 216 are preferably arranged in a strip shape. Each first light guiding portion 218 has an incident side 218a beside which the light emitting elements 214 are disposed.

In the embodiment, the touch control module 220 may be a resistive touch control module or capacitive touch control module, and it detects an instruction according to the change of the electronic characteristic such as the capacitance value or the resistance value that varies when a user presses on the touch control module 220. Then, a computing unit such as the application-specific integrated circuit (ASIC) that conventionally implemented in the electronic computes to generate a cursor signal, and the computing unit also computes out a track of the instruction to generate a drag effect. The touch control module 220 is coinciding with the first light guiding plate 212. The controller 230 is electrically connected to the light emitting elements 214 and the touch control module 220, and it controls at least part of the light emitting elements 214 to emit light according to an instruction detected by the touch control module 220.

To the light emitting touchpad 200 in the embodiment, when the user touches the light emitting touchpad 200, at least part of the light emitting touchpad 200 flashes to provide visual feedback for the user. Therefore, the light emitting touchpad 200 provides an aesthetic light flashing effect, which provides real-time interactive and facilitates the user to control the electronic device 100.

As shown in FIG. 2 and FIG. 3, the first blocking walls 216 and the first light guiding portions 218 and the first light guiding portions 218 are interlacing with each other, and the light emitting elements 214 are disposed at incident sides 218a. Therefore, the light emitting module 210 may generate a light emitting pattern as shown in FIG. 1 in the light emitting touchpad 200. Furthermore, in the light emitting touchpad 200 in the embodiment, as the user the touch control module 220 senses different positions on the touchpad 200 touchesed by in different position of the light emitting touchpad 200 for providing instruction the user, the controller 230 also may control at least part of the light emitting elements 214 that corresponding to the area at the touched position to emit light according to the touch control module 220. Thus In this manner, the light emitting area on the light emitting touchpad 200 varies with the movement of the touched position, which provides a visual dynamical variation plus aesthetic light flashing effect that provides real-time interactive operational feeling image effect for the user to improve the operational feeling of the user when he or she operates the light emitting touchpad 200. Although the light emitting touchpad 200 is taken as an example herein, in other embodiments, the light emitting touchpad 200 may sense the position of a finger, a touch pen or another touching tool when the user does not touch the light emitting touchpad 200 directly. Implementations depend on the characteristic of the touch control modules 200. In the embodiment, the light emitting module 210 is coinciding with the touch control module 220. Otherwise, the touch control module 220 also may be coinciding with the light emitting module 210, which is not limited herein.

Furthermore, the first light guiding plate 212 further includes a first reflecting layer 244 disposed at a bottom surface 212b of the first light guiding plate 212. The first reflecting layer 244 may be a white reflecting film attached to the bottom surface 212b of the first light guiding plate 212. Thus, when the light emitting elements 214 emit light, the light scattered to the bottom surface 212b is reflected by the first reflecting layer 244 to increase the brightness of the first light guiding plate 212. In addition, in another embodiment, the first reflecting layer also may be formed by coating white reflecting ink on the bottom surface 212b of the first light guiding plate 212 to allow the light to be reflected by the first reflecting layer and increase the brightness of the first light guiding plate 212.

In the embodiment, the first light guiding portions 218 have a plurality of the dots 212a disposed on the top surfaces 218b of the first light guiding portion 218. When the light transmitted in the first light guiding portions 218, the printed dots 212a may avoid total reflection of the light, and may enhance emission of the light in the first light guiding portions 218. In addition, since the light is weaker at the part of the first light guiding portions 218 away from the incident sides 218a, the distributing density of the printed dots 212a in the area adjacent to the incident sides 218a is less than that of the printed dots 212a in the area far away form the incident sides 218a. Thus, the light generated by the light emitting elements 214 is compensated for the weakness due to the increase of the distance. Thus, the first light guiding portions 218 may evenly emit the light.

To achieve the layout of the distributing density, the number of the printed dots 212a may be increased, or the size of the printed dots 212a at different positions also may be changed. The printed dots 212a also may be presented in other forms, and the means for utilizing the layout of the distributing density is not limited thereto.

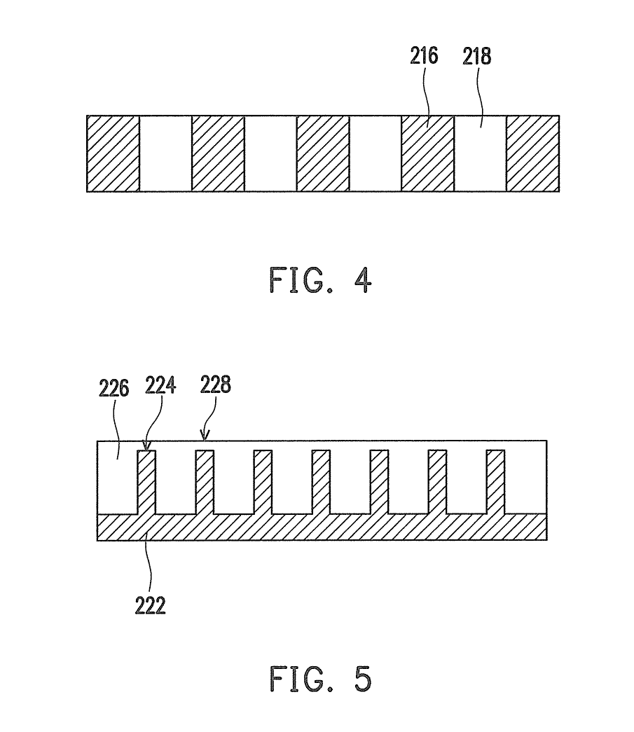

FIG. 4 is a sectional diagram showing the first light guiding plate in FIG. 2 taken along the S plane. As shown in FIG. 4, in the embodiment, the first blocking walls 216 and the first light guiding portions 218 are assembled to be one-piece after individually formed. The first blocking walls 216 and the first light guiding portions 218 also may be integrally formed via the dual-injection molding process to save the cost and manpower.

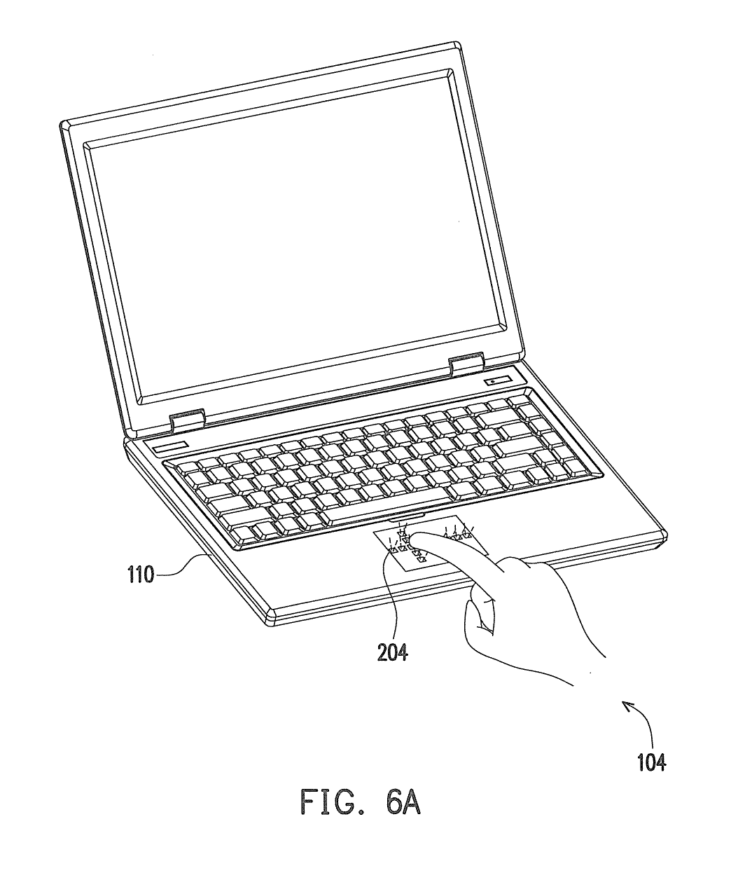

FIG. 5 is a sectional diagram showing a first light guiding plate in the light emitting module of another embodiment. Different from the former embodiment, a proper distance is formed between the top 224 of the first blocking wall 222 and a surface 228 of the first light guiding portion 226. Thus, when the light emitting elements 214 emit light, the user would not see the separating lines, but see a vague flashing glimmer caused by the first light guiding portions to have a preferred visual sensation.

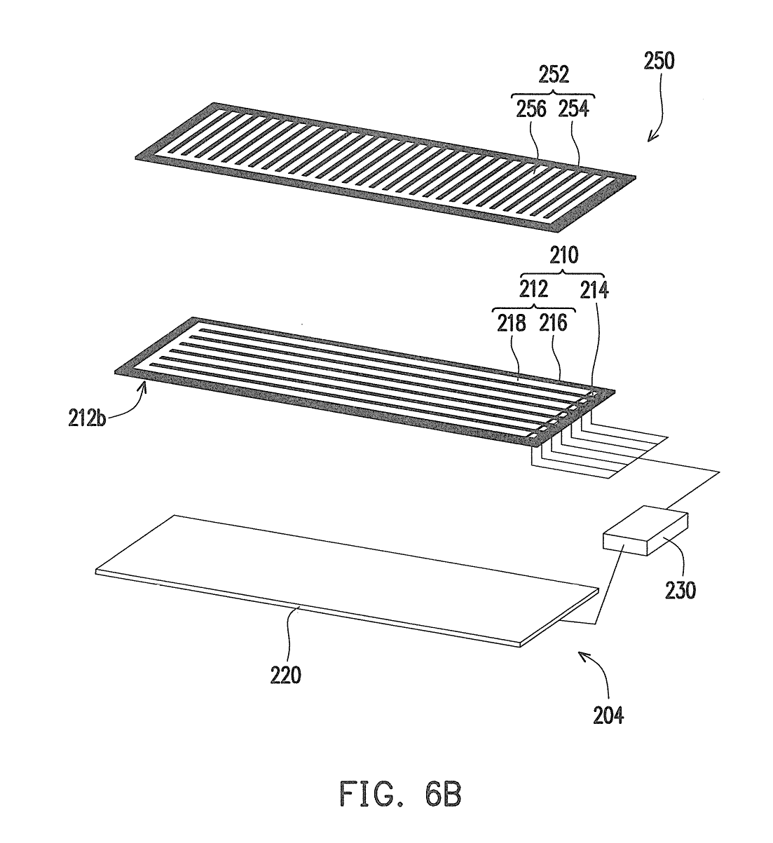

FIG. 6A is a schematic diagram showing an electronic device according to another embodiment of the invention. FIG. 6B is an exploded diagram showing the light emitting touchpad 204 in the electronic device in FIG. 6A. Compared with the light emitting module 210 in the former embodiment, in the electronic device 104 in the embodiment, the light emitting module 250 of the light emitting touchpad 204 has a second light guiding plate 252 that coincides with the first light guiding plate 212. The second light guiding plate 252 includes a plurality of second blocking walls 254 and a plurality of second light guiding portions 256. The second blocking walls 254 and the second light guiding portions 256 are interlacing with each other. The second blocking walls 254 and the second light guiding portions 256 are in a perpendicular orientation relative to the first blocking walls 216 and the first light guiding portions 218. Therefore, when a finger touches and presses the light emitting touchpad 204, the light emitting pattern as shown in FIG. 6A is generated.

Similarly, in the embodiment, the second light guiding portions 256 and the second blocking walls 254 of the second light guiding plate 252 may be assembled after individually manufactured, and they also may be integrally formed via the dual injection molding process. Means for combining the blocking walls and the light guiding portions is not limited herein.

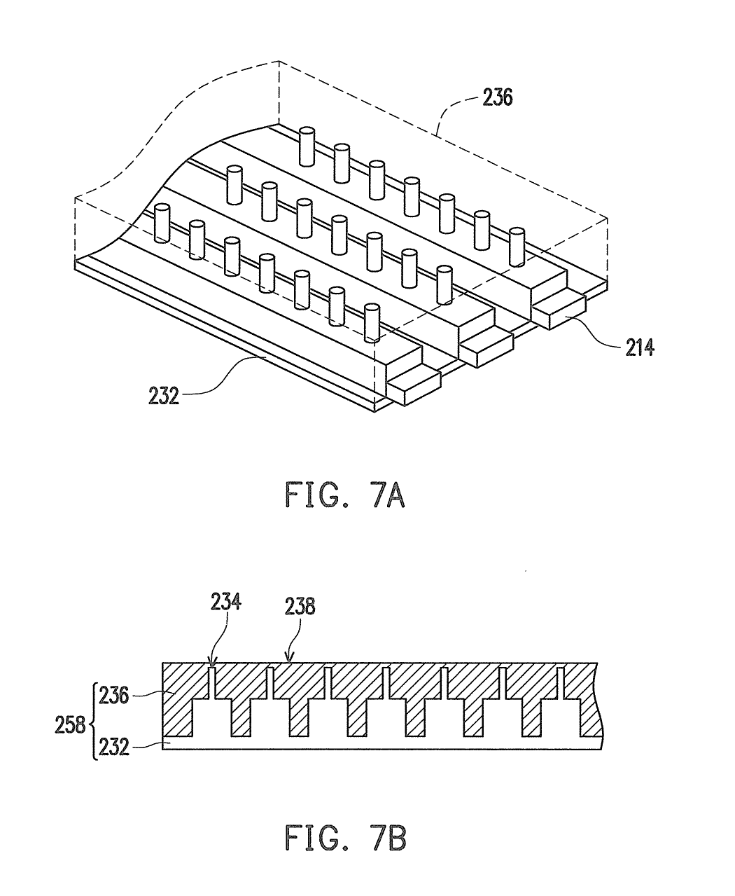

FIG. 7A is a partial schematic diagram showing the first light guiding plate and the light emitting elements of the light emitting modules in another embodiment of the invention. FIG. 7B is a partial sectional diagram showing the first light guiding plate in FIG. 7A. To clearly show the structure of the first light guiding plate 258, the first blocking walls 236 in FIG. 7A is drawn in dotted lines. As shown in FIG. 7A and FIG. 7B, different from the former embodiment in which the first light guiding portions 226 are coinciding on the first blocking walls 224, in this embodiment, the first blocking walls 236 are coinciding on the first light guiding portions 232, and the light emitting elements 214 are disposed beside the first light guiding portions 232. Furthermore, each first light guiding portion 232 has multiple beams 234 integrally formed thereon and extending upward.

Besides, the light emitting elements 214 may also disposed at the middle layer of the first light guiding portions 232 instead of the bottom layer. Thus, the scattered light is decreased to improve the light source utilization ratio.

In such manner, a top of the beam 234 of the first light guiding portion 232 may be revealed in a surface 238 of the first blocking wall 236, or keeps a proper distance from the surface 238 of the first blocking wall 236 as shown in FIG. 7B. Therefore, when the light emitting elements 214 do not emit light, the appearance of the surface of the first light guiding plate 258 is the same as that of a normal touchpad. When the light emitting elements 214 emit light, the light penetrates the first blocking walls 236 from the beams 234 of the first light guiding portions 232 and thus the surface of the first light guiding plate 258 presents dot-shaped lineal light emitting pattern.

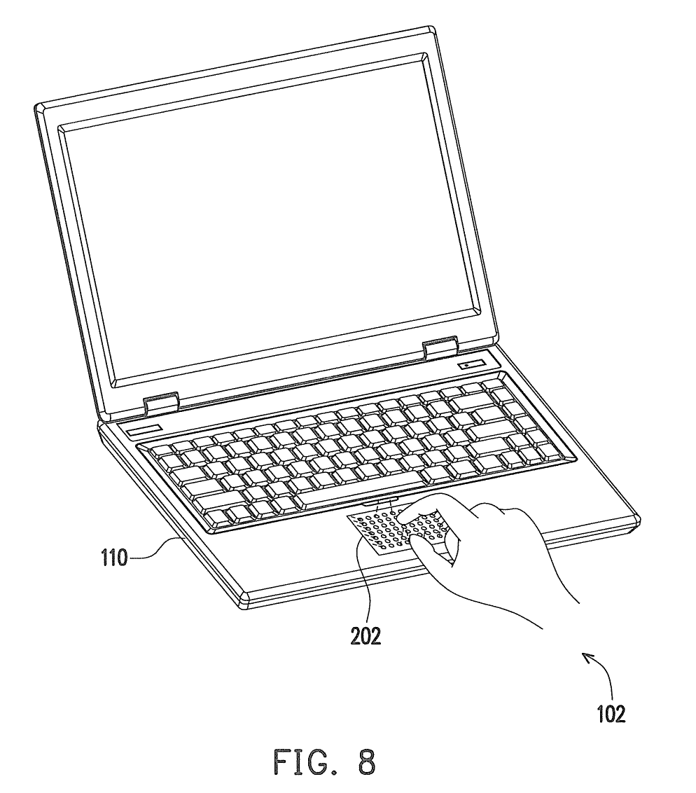

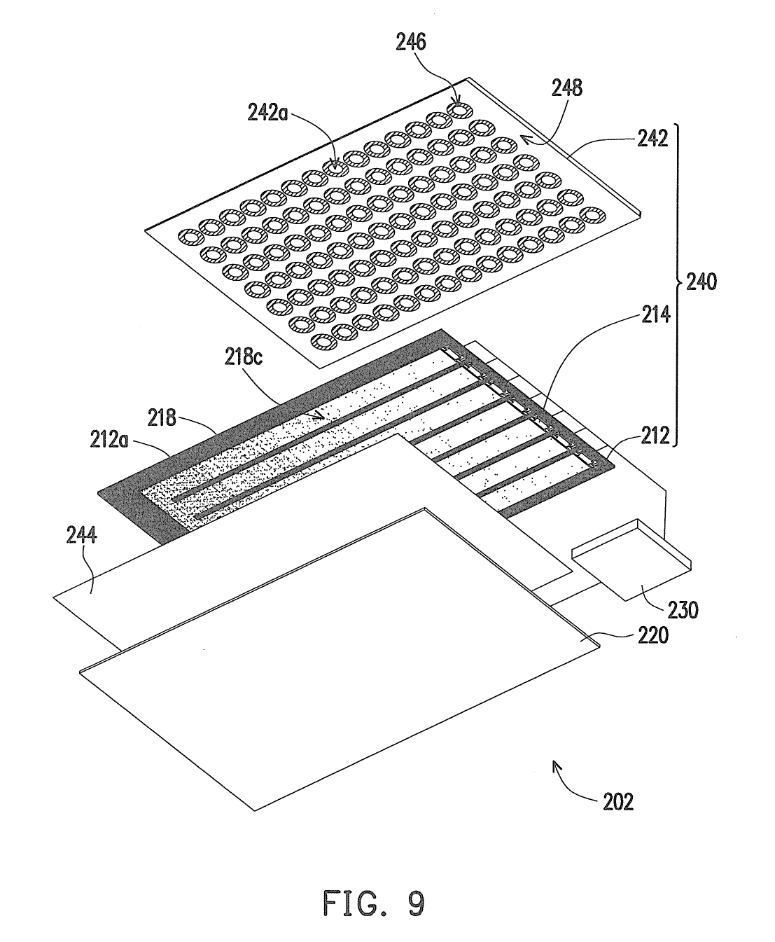

FIG. 8 is a schematic diagram showing the electronic device according to another embodiment. FIG. 9 is an exploded diagram showing the light emitting touchpad 202 of the electronic device in FIG. 8. As shown in FIG. 8 and FIG. 9, different from that in the former embodiment, the light emitting module 240 in the light emitting touchpad 202 of the electronic device 102 further includes a pattern plate 242 coincides with the first light guiding plate 212. The pattern plate 242 has a plurality of dot-shaped penetrating portions 242a directly facing the first light guiding portions 218 to allow the light transmitted by the first light guiding portions 218 to pass the dot-shaped penetrating portions 242a. Thus, the light emitting module 240 generates the dot-shaped light emitting pattern shown in FIG. 8 when it emits light.

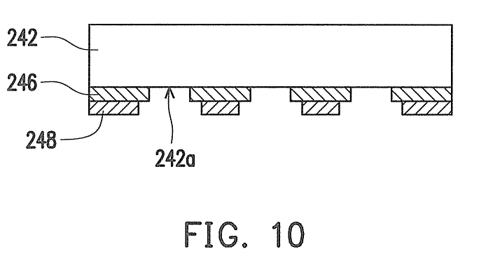

FIG. 10 is a sectional diagram showing the pattern plate in FIG. 9. As shown in FIG. 9 and FIG. 10, the dot-shaped penetrating portion 242a of the pattern plate 242 is, for example, an area passable for the light formed by plating the surface of the pattern plate 242 with a photomask and etching. The pattern plate 242 further has a second reflecting layer 248 disposed at a surface of the pattern plate 242 where the pattern plate 242 mount with the first light guiding plate 212 to reflect the light which fails to be transmitted through the dot-shaped penetrating portions 242a to the first reflecting layer 244. Thus, the light may be reflected repeatedly between the first reflecting layer 244 and the second reflecting layer 248 to increase the light utilization ratio of the first light guiding plate 212. The second reflecting layer 248 is, for example, formed by coating a layer of white reflecting ink on the photomask 246 or attaching a white reflecting film on the pattern plate 242. The methods for manufacturing the dot-shaped penetrating portions 242a and the second reflecting layer 248 are not limited. In another embodiment of the invention, the method for manufacturing the pattern plate may be the same as that for manufacturing the first light guiding plate 212. That is, the pattern plate may be formed by combining a photomask with a dot-shaped penetrating part.

As shown in FIG. 9, the first light guiding portions 218 have a plurality of printed dots 212a disposed at the bottom surface 218c of the first light guiding portions 218. However, the positions of the printed dots 212a on the first light guiding portions 218 are not limited. In another embodiment, the printed dots also may be both at the top surfaces and bottom surfaces of the first light guiding portions to make the first light guiding plate 212 generate even light.

To sum up, the light emitting touchpad of the electronic device in the invention has a light emitting module, and therefore, when the user operates the light emitting touchpad, the part of light emitting touchpad touched by the user is lightened to provide a visual feedback to the user. Thus, the user may obtain a preferred operational feeling.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of.

What is claimed is:

1. A light emitting touchpad comprising:
a light emitting module including a first light guiding plate and a plurality of light emitting elements, wherein the first light guiding plate includes a plurality of first blocking walls and a plurality of first light guiding portions, the first blocking walls and the first light guiding portions are interlacing with each other, each of the first light guiding portions has an incident side, and the light emitting elements are disposed beside the incident sides;
a touch control module coinciding with the first light guiding plate; and
a controller electrically connected to the light emitting elements and the touch control module, wherein the controller controls at least part of the light emitting elements to emit light according to an instruction detected by the touch control module.

2. The light emitting touchpad according to claim 1, wherein the light emitting elements comprise a plurality of light emitting diodes.

3. The light emitting touchpad according to claim 1, wherein the light emitting module further comprises a second light guiding plate coinciding with the first light guiding plate, the second light guiding plate comprises a plurality of second blocking walls and a plurality of second light guiding portions, the second blocking walls and the second light guiding portions are interlacing with each other, and the second blocking walls and the second light guiding portions are in a perpendicular orientation relative to the first blocking walls and the first light guiding portions.

4. The light emitting touchpad according to claim 3, wherein the second blocking walls and the second light guiding portions are integrally formed.

5. The light emitting touchpad according to claim 1, wherein the first light guiding plate further comprises a first reflecting layer disposed at a bottom surface of the first light guiding plate.

6. The light emitting touchpad according to claim 1, wherein the light emitting module further comprises a pattern plate coinciding with the first light guiding plate, and the pattern plate has a plurality of dot-shaped penetrating portions directly facing the first light guiding portions.

7. The light emitting touchpad according to claim 6, wherein the pattern plate further has a second reflecting layer disposed at a surface of the pattern plate where the pattern plate mount with the first light guiding plate.

8. The light emitting touchpad according to claim 1, wherein the first blocking walls and the first light guiding portions are integrally formed.

9. The light emitting touchpad according to claim 1, wherein the first light guiding portions have a plurality printed dots formed thereon.

10. The light emitting touchpad according to claim 9, wherein the distributing density of the printed dots in the area adjacent to the incident sides is less than the distributing density of the printed dots in the area far away from the incident sides.

11. An electronic device, comprising:
a main body; and
a light emitting touchpad disposed at the main body, the light emitting touchpad including:
a light emitting module including a first light guiding plate and a plurality of light emitting elements, wherein the first light guiding plate includes a plurality of first blocking walls and a plurality of first light guiding portions, the first blocking walls are disposed between the first light guiding portions, each of the first light guiding portions has an incident side, and the light emitting elements are disposed beside the incident sides;
a touch control module coinciding with the first light guiding plate; and
a controller electrically connected to the light emitting elements and the touch control module, wherein the controller controls at least part of the light emitting elements to emit light according to an instruction detected by the touch control module.

12. The electronic device according to claim 11, wherein the light emitting elements comprise a plurality of light emitting diodes.

13. The electronic device according to claim 11, wherein the light emitting module further comprises a second light guiding plate coinciding with the first light guiding plate, the second light guiding plate comprises a plurality of second blocking walls and a plurality of second light guiding portions, the second blocking walls are disposed between the second light guiding portions, and the second blocking walls and the second light guiding portions are in a perpendicular orientation relative to the first blocking walls and the first light guiding portions.

14. The electronic device according to claim 13, wherein the second blocking walls and the second light guiding portions are integrally formed.

15. The electronic device according to claim 11, wherein the first light guiding plate further comprises a first reflecting layer disposed at a bottom surface of the first light guiding plate.

16. The electronic device according to claim 11, wherein the light emitting module further comprises a pattern plate coinciding with the first light guiding plate, and the pattern plate has a plurality of dot-shaped penetrating portions directly facing the first light guiding portions.

17. The electronic device according to claim 16, wherein the pattern plate further has a second reflecting layer disposed at a surface of the pattern plate where the pattern plate mount with the first light guiding plate.

18. The electronic device according to claim 11, wherein the first blocking walls and the first light guiding portions are integrally formed.

19. The electronic device according to claim 11, wherein the first light guiding portion has a plurality of printed dots.

20. The electronic device according to claim 19, wherein the distributing density of the printed dots in the area adjacent to the incident sides is less than the distributing density of the printed dots in the area far away form the incident sides.
